(19) United States
(12) Patent Application Publication
(10) Pub. No.: US 2012/0214326 A1
(43) Pub. Date: Aug. 23, 2012

(54) CABLE CONNECTOR ASSEMBLY ADAPTED FOR POWER AND SIGNAL TRANSMITTING

(75) Inventors: David Ko, Fullerton, CA (US); Chi-Ming Chen, New Taipei (TW); Jun Zong, Kunshan (CN); Chang-Mao Li, Kunshan (CN)

(73) Assignee: HON HAI PRECISION INDUSTRY CO., LTD., New Taipei (TW)

(21) Appl. No.: 13/400,874

(22) Filed: Feb. 21, 2012

(30) Foreign Application Priority Data
Feb. 18, 2011 (CN) 201120041968.0

(51) Int. Cl. H01R 13/62

(52) U.S. Cl. 439/345

(57) ABSTRACT

A cable connector assembly (100) includes a first connector (1) used for transmitting power, a second connector (2) for transmitting signal, a cover (3) holding the first connector and the second connector, a cable (4) connected with the first connector and the second connector and a ferrule (12) mounted to the cover. The first connector has a body portion (111), the ferrule has a main portion (121) around the body portion of the first connector and a number of equally spaced spring tabs (123), the spring tabs are extending along a transverse direction and elastically pressing onto the body portion of the first connector.

### CROSS-REFERENCE TO RELATED APPLICATION

This application is related to U.S. patent application Ser. No. 13/290,152 filed on Nov. 7, 2011 and entitled “CABLE ASSEMBLY ADAPTED FOR POWER AND SIGNAL TRANSMITTING,” which has the same applicant and assignee as the present invention.

### BACKGROUND OF THE INVENTION

1. Field of the Invention

The present invention relates to a cable connector assembly, especially to a cable connector assembly adapted for power and signal transmitting.

2. Description of Related Art

CN Patent No. 200820303305.X issued on Oct. 28, 2009 to Su et al. discloses a cable connector assembly which comprises a first cable connector, a circuit board installed inside the first cable connector, a shielding shell surrounding about the circuit board, and an insulating shell positioned outside the shielding shell. An end of the circuit board is connected with two cables extending out of the shielding shell; the two cables in turn are respectively connected with a second cable connector complying with the Display Port standard and a third cable connector complying with the USB standard. The cable connector assembly has the improved structure and is provided with an additional USB connector for supplying power.

However, the second cable connector and the third cable connector are respectively plugged into receptacle connectors. Sometimes, it is inconvenient for using such cable connector assembly.

Hence, a cable connector assembly with two mating ports for simultaneously mating with receptacle connectors is desired.

### SUMMARY OF THE INVENTION

An object of the present invention is to provide a cable connector assembly with an improved ferrule providing enough elastic force.

Accordingly, to achieve above-mentioned object, a cable connector assembly comprises a first connector used for transmitting power, a second connector for transmitting signal, a cover holding the first connector and the second connector, a cable connected with the first connector and the second connector and a ferrule mounted to the cover. The first connector has a body portion, the ferrule has a main portion around the body portion of the first connector and a number of equally spaced spring tabs, the spring tabs are extending along a transverse direction and elastically pressing onto the body portion of the first connector.

The detailed features of the present invention will be apparent in the detailed description with appropriate reference to the accompanying drawings.

### BRIEF DESCRIPTION OF THE DRAWINGS

FIG. 1 is a perspective view of a cable connector assembly in accordance with the present invention;

FIG. 2 is similar to FIG. 1, with a dustproof cap moved away from a port of the cable connector assembly;

FIG. 3 is a partially exploded, perspective view of the cable connector assembly;

FIG. 4 is similar to FIG. 3, but viewed from other aspect;

FIG. 5 is an exploded, perspective view of the cable connector assembly;

FIG. 6 is similar to FIG. 5, but viewed from other aspect;

FIG. 7 is an exploded, perspective view of a second connector in FIG. 3; and

FIG. 8 is a partially assembled view of FIG. 7, but viewed from other aspect.

### DETAILED DESCRIPTION OF THE INVENTION

Reference will now be made in detail to the preferred embodiment of the present invention.

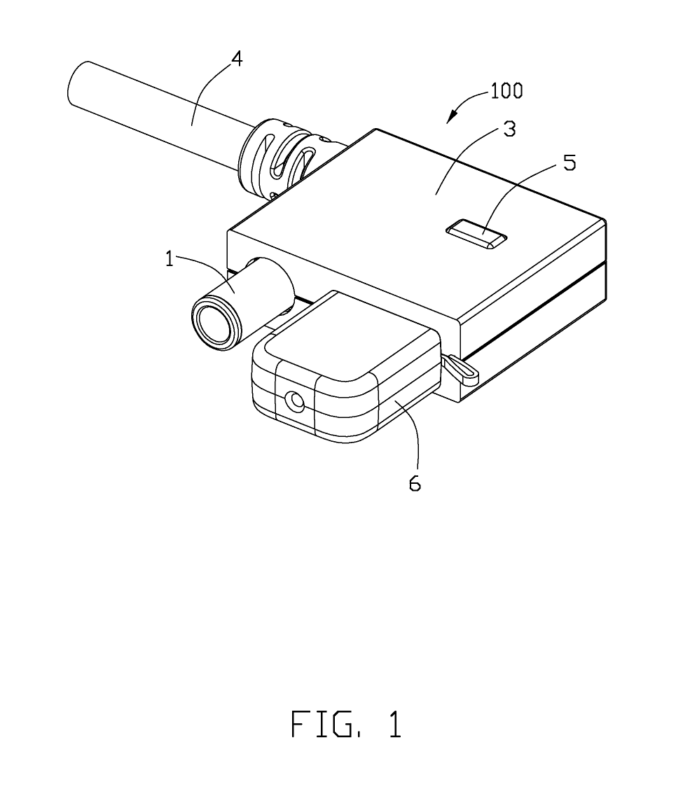

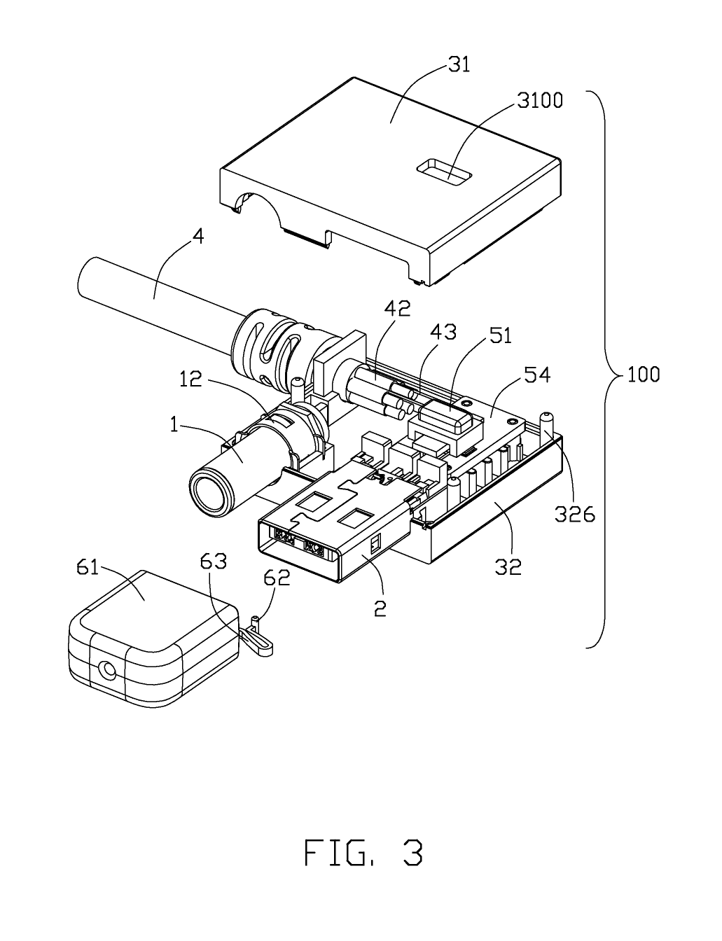

Referring to FIGS. 1-3, a cable connector assembly 100 in accordance with the present invention comprises a first connector 1, a second connector 2, a cover 3, a cable 4 connected with the first connector 1 and the second connector 2, a switch device 5 and a dustproof cap 6. The first connector 1 and the second connector 2 are arranged in juxtaposed manner and held by the cover 3. The cable connector assembly 100 also has a ferrule 12 mounted to the cover and enclosing the first connector 1.

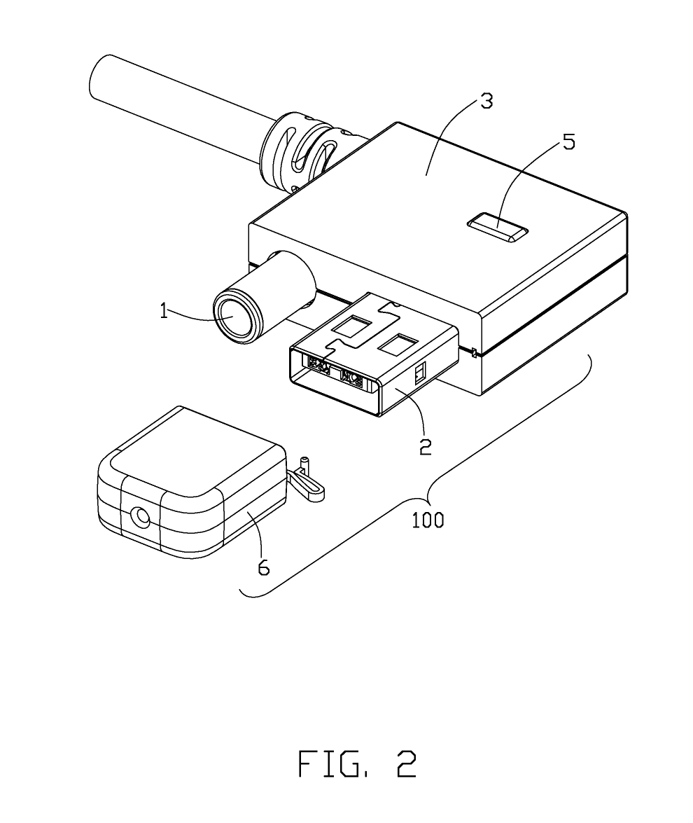

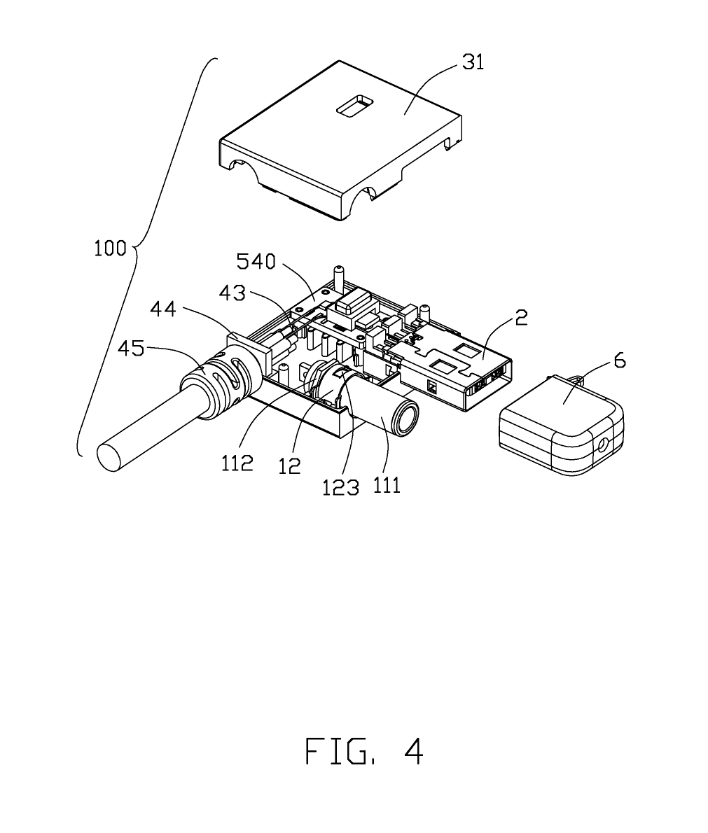

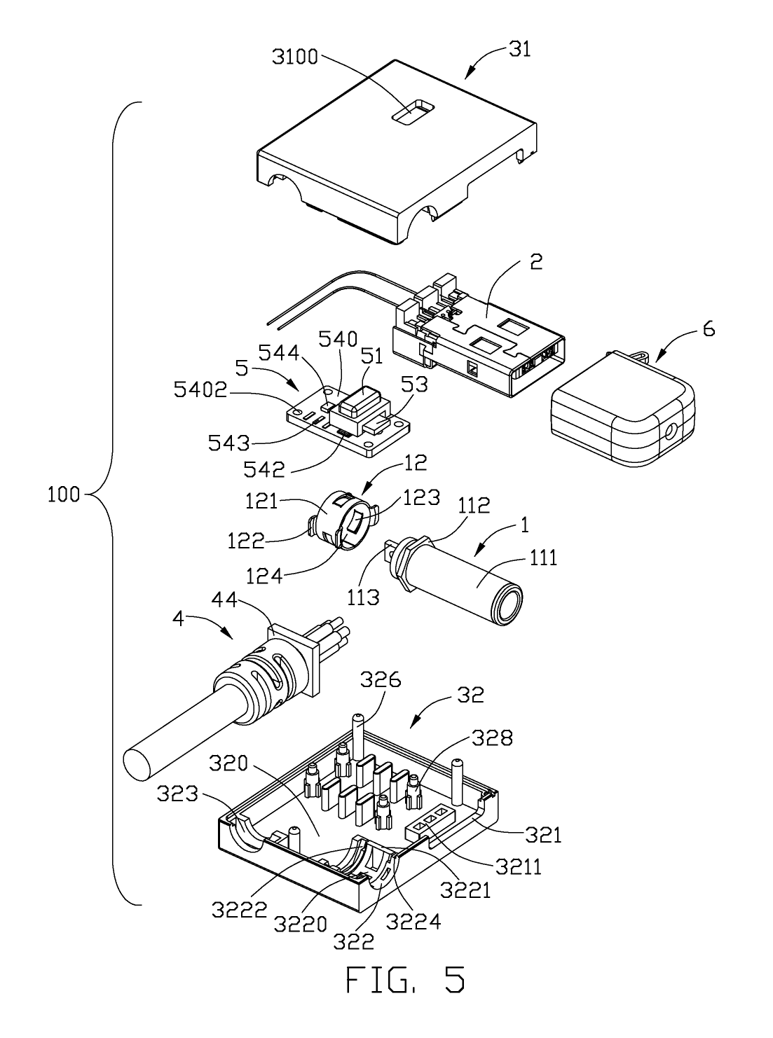

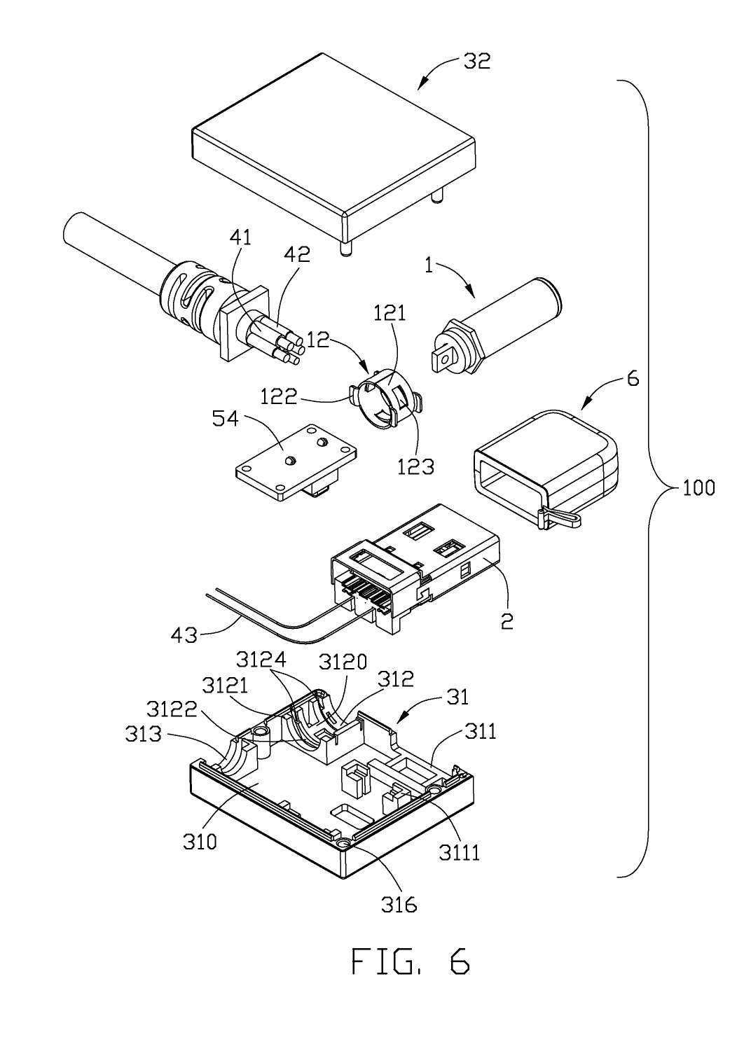

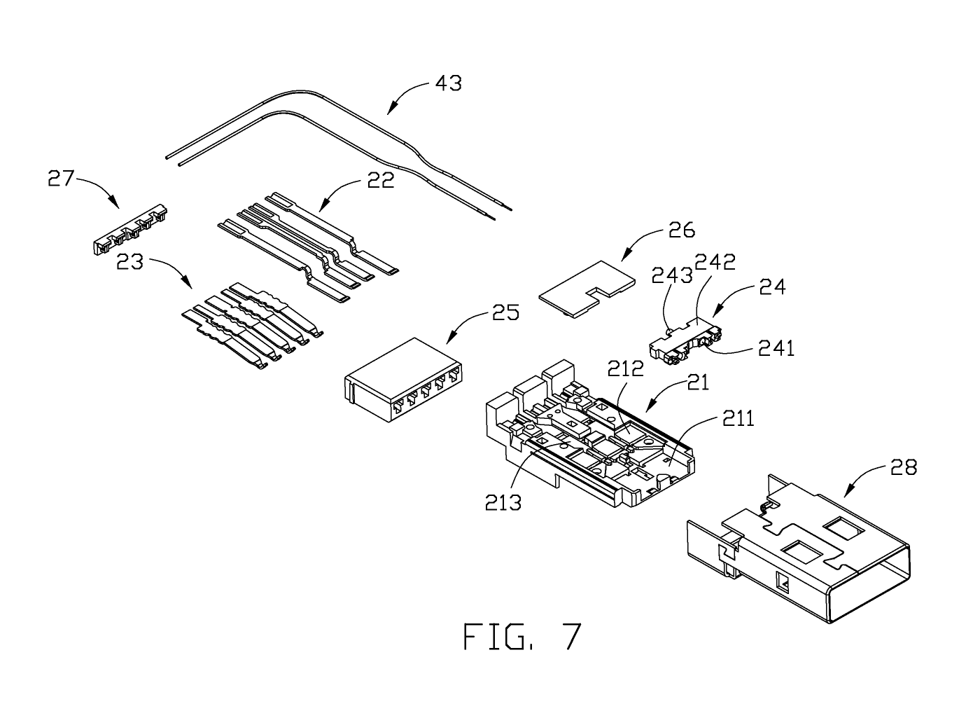

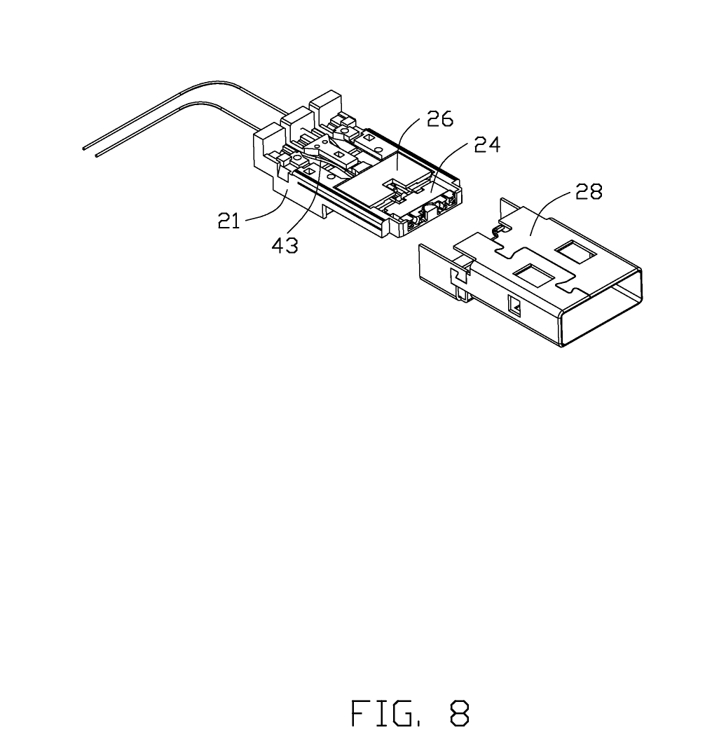

Referring to FIGS. 2-8, the first connector 1 is a power connector, and it transmits DC power in the present invention. The first connector 1 includes an elongated cylindrical shaped body portion 111, a hexagonal shaped flange 112 located at a back segment thereof and a linking portion 113 behind the flange 112. The body portion 111 and the flange 112 can be designed with other shapes respectively.

The second connector 2 is adapted for transmitting signal. The second connector 2 includes an insulative housing 21, a set of first pins 22 mounted to the insulative housing 21, a set of second pins 23 combined with a contact seat 25 and assembled to the insulative housing 21 and a metallic shell 28 enclosing the insulative housing 21. The first pins 22 are assembled to the insulative housing 21 directly, and the second pins 23 are assembled to the contact seat 25 firstly, and then a positioning member 27 is attached to a back segment of the contact seat 25 to secure the second pins 23, the contact seat 25 is accommodated in a mounting cavity (not shown) in a back segment of the insulative housing 21. The first pins 22 and the second pins 23 are arranged offset from each other along a front-to-back direction, and in accordance with USB 3.0 standard.

The insulative housing 21 defines a cavity 211 in a front segment thereof, a pair of depressions 212 behind and neighboring to the cavity 211, and a pair of grooves 213 behind the corresponding depressions 212, the grooves 213 are communicated with the corresponding depressions 212.

The second connector 2 further includes an optical module 24 accommodated in the cavity 211 of the insulative housing 21. The optical module 24 has a number of lenses 241 arranged in a row and enclosed in a retainer 242. A post 243 is formed on a back side of the retainer 242, and a coil spring (not shown) is assembled to the retainer 242, the post 243 is inserted into a front end of the coil spring.

The ferrule 12 is mounted to the back segment of the body portion 111 of the first connector 1, and a rear end of the ferrule 12 is adjacent to a front end of the flange 112. The ferrule 12 includes a circular shaped main portion 121 enclosing a hollow 124 therein. The hollow 124 is larger than the body portion 111 but smaller than the flange 112. Therefore, the body portion 111 may active or floatable inside the hollow 124 along a radial direction, but not escape from the hollow 124 along an axial direction by stopping of the flange 112. Thus the first connector 1 is conically floatable with regarding to the cover 3, under the condition that a distance between the first connector 1 and the second connector 2 is variable so as to facilitating the cable connector assembly 100 mating with a complementary connector. There are two pairs of retaining tabs 122 respectively formed at a front and a back edges of the main portion 121 and oppositely arranged regarding to the axial direction, the retaining tabs 122 on a same side are arranged along the front-to-back direction.

In addition, there are several spring tabs 123 formed on the main portion 121 and extending into the hollow 124, the spring tabs 123 are arranged on the main portion 121 equi-distantly and pressing onto and therefore centering the body portion 111 of the first connector 1. As the size of the cable connector assembly 100 is smaller, the ferrule 12 has a smaller length along an axial direction, the spring tabs 123 are defined extending along a transverse direction, i.e., the spring tabs 123 are arranged on the main portion 121 along a circumferential direction. Each spring tab 123 can be assigned on a larger area as the main portion 121 having a larger perimeter, and each spring tab 123 can be designed with larger length along the transverse direction to provide enough elastic force for the body portion 111 of the first connector 1. In present embodiment, there are three spring tabs 123 arranged along circumferential direction of the hollow 124. Furthermore, the body portion 111 and the main portion 121 of the ferrule 12 are coaxially disposed, with an equal gap therebetween. The gap has a dimension about 0.3 mm along the radial direction. This gap permits a slight misalignment between the first and second connectors.

The cover 3 includes a top cover 31 and a bottom cover 32 assembled together.

The top cover 31 defines a first receiving space 310 which communicates with an exterior via a first semicircular shaped opening 312 and a first rectangular shaped opening 311 in a front side of the top cover 31 and a first semicircular shaped outlet 313 in a lateral side of the top cover 31. There is a first upper positioning portion 3121 located adjacent to and behind the first semicircular shaped opening 312. There is a second upper positioning portion 3111 located in the receiving space 310 and behind the first rectangular shaped opening 311. The first upper positioning portion 3121 defines a semicircular shaped mounting recess 3120 aligning with and communicating with the first semicircular opening 312 for receiving the body portion 111. There is a slot 3122 located in a back segment of the mounting recess 3120 for receiving the flange 112. A pair of slits 3124 are located in front of and adjacent to the slot 3122, and the pair of slits 3124 are spaced apart from each other along the front-to-back direction. The ferrule 12 is accommodated in the mounting recess 3120, with the retaining tabs 122 engaged with the slits 3124. There is a window 3100 defined in a top wall of the top cover 31 and the window 3100 further communicates with the receiving space 310. In addition, there are a number positioning holes 316 located in the receiving space 310 and adjacent to the lateral sides of the top cover 31.

The bottom cover 32 defines a second receiving space 320 which communicates with exterior via a second semicircular shaped opening 322 and a second rectangular shaped opening 321 in a front side of the bottom cover 32 and a second semicircular shaped outlet 323 in a lateral side of the bottom cover 32. There is a first lower positioning portion 3221 located adjacent to and behind the second semicircular shaped opening 322. There is a second lower positioning portion 3211 located in the second receiving space 320 and behind the second rectangular shaped opening 321. The first lower positioning portion 3221 defines a semicircular shaped mounting recess 3220 aligning with and communicating with the second semicircular opening 322 for receiving the body portion 111. There is a slot 3222 located in a back segment of the mounting recess 3220 for receiving the flange 112. A pair of slits 3224 are located in front of the slot 3222 and spaced apart from each other along the front-to-back direction. In addition, there are a number positioning posts 326 located in the receiving space 320 and adjacent to the lateral sides of the bottom cover 32. A plurality of standoffs 328 are defined in the receiving space 320 and located on inner side of the positioning posts 326, the standoffs 328 are located behind the second lower positioning portion 3211.

The cable 4 includes a pair of first wires 41, three second wires 42, and a pair of fibers 43. The first wires 41 are connected with the first connector 1 for transmitting power, and the second wires 42 are connected with conductive pads 543 on a PCBA (printed circuit board assembly) 54 and the switch device 5. Wires connected with the first pins 22 and the second pins 23 of the second connector 2 are not shown in Figures. The cable 4 also has a strain relief portion 45 thereon and an orientation portion 44 in front of the strain relief portion 45. The fibers 43 are passing through corresponding grooves 213 in the insulative housing 21 and extend into the cavity 211 to couple with the lenses 241. A retaining board 26 is positioned in a depression 212 of the insulative housing 21 so as to confine the optical module 24 and the fibers 43.

The switch device 5 includes a button 51, a spring (not shown), a supporting member 53 and the PCBA (printed circuit board assembly) 54.

The PCBA 54 includes a circuit substrate 540 and two LEDs (Light emitting diode) 542 disposed at opposite sides thereof. There are three conductive pads 543 disposed behind the LEDs 542. There is circuit protective element 544 mounted to the circuit substrate 540. Four positioning holes 5402 are located in four corners of the circuit substrate 540.

The circuit substrate 540 is accommodated in the second receiving space 320 of the bottom cover 32, with the four standoffs 328 of the bottom cover 32 respectively inserted into the four positioning holes 5402 of the circuit substrate 540. When pressing the button 51, light from the LEDs 542 can pass through the button 51 with circuit of the circuit substrate 540 turn on, to indicate work status of the cable connector assembly 100.

The dustproof cap 6 includes a shielding portion 61, a pivot 62 assembled to the cover 3 and a linking rod 63 connecting with the shielding portion 61 and the pivot 62.

The first connector 1 and the second connector 2 are mounted to the cover 3. The ferrule 12 is fixed to the mounting recess 3120 of the first upper positioning portion 3121 and the mounting recess 3220 of the first lower positioning portion 3221, the retaining tabs 122 are received in the slits 3124, 3224. The back segment of the body portion 111 is floatably mounted into the hollow 124 of the ferrule 12, and the flange 112 of the first connector 1 is received in the slots 3122, 3222; therefore, the first connector 1 are movably or floatably with regarding to the cover 3 along the radial direction which perpendicular to a mating direction. The second connector 2 is securely positioned between the second upper positioning portion 3111 and the second lower positioning portion 3211. The dustproof cap 6 is mounted onto a front end of the cover 3, with the pivot 62 connected with the cover 3 and the shielding portion 61 enclosing the second connector 2, and the shielding portion 61 can be moved away from the second connector 2 while the pivot 62 still connected with the cover 3.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable connector assembly, comprising:
a first connector used for transmitting power, the first connector having a body portion;
a second connector for transmitting signal;
a cover holding the first connector and the second connector;
a cable connected with the first connector and the second connector; and
a ferrule mounted to the cover and having a main portion around the body portion of the first connector and a plurality of equally spaced spring tabs, the spring tabs extending along a transverse direction and elastically pressing onto the body portion of the first connector.

2. The cable connector assembly as claimed in claim 1, wherein the ferrule has a plurality of retaining tabs formed at opposite ends of the main portion symmetrically, and the retaining tabs on a same side are arranged along a front-to-back direction.

3. The cable connector assembly as claimed in claim 2, wherein the ferrule is hollow, and the spring tabs extend into to press the first connector.

4. The cable connector assembly as claimed in claim 3, wherein the first connector has a rear flange, and a rear end of the ferrule is adjacent to a front end of the flange.

5. The cable connector assembly as claimed in claim 4, wherein both the main portion and the body portion are substantially cylindrical, and there is an annular gap between the main portion and the body portion.

6. The cable connector assembly as claimed in claim 1, wherein the first connector is floatable with respect to the cover, and the second connector is securely assembled with the cover.

7. The cable connector assembly as claimed in claim 6, wherein the first connector and the second connector are arranged in juxtaposed manner.

8. The cable connector assembly as claimed in claim 7, wherein the second connector is a USB 3.0 connector.

9. The cable connector assembly as claimed in claim 8, wherein the second connector also comprises an optical module.

10. The cable connector assembly as claimed in claim 1, wherein a plurality of mounting recesses are arranged in the cover, and the ferrule is accommodated in the mounting recesses of the cover.

11. The cable connector assembly as claimed in claim 10, wherein each mounting recess defines a slot and a pair of slits, the first connector comprises a flange received in the slot, and the ferrule comprises a pair of retaining tabs received in the slits.

12. The cable connector assembly as claimed in claim 11, wherein the pair of slits are spaced apart from each other along a front-to-back direction.

13. The cable connector assembly as claimed in claim 1, wherein the spring tabs are disposed on the main portion along a circumferential direction.

14. A connection system comprising:
a host connector set including:
first and second host connectors side by side arranged with each other;
a cable connector set including:
first and second a guest connectors side by side arranged with each other; wherein
at least either the first and second host connectors of the host connector set or the first and second guest connectors of the cable connector set have the corresponding mating ports transversely moveable relative to each other so as to provide self-adjustable coupling during mating the host connector set and the guest connector set; wherein
the mating ports of the first and second guest connectors of the guest connector set are transversely moveable relative to each other under condition that the guest connector set includes a cable extending away from a holder into which the first guest connector and the second guest connector are retained; wherein
said second guest connector having the corresponding mating port moveable relative to the holder, defines an outer ferrule enclosing the corresponding mating port under condition that some spring tangs are formed between the outer ferrule and the mating port to have the mating port floatable relative to the outer ferrule; wherein
the spring tangs extend along an extension direction angled with a front-to-back direction of the ferrule which is perpendicular to a transverse direction along which the mating ports of the first and second guest connectors of the guest connector set are moveable relative to each other.

15. The connection system as claimed in claim 14, wherein the mating port of the first guest connector of the guest connector set defining long and short sides perpendicular to each other, is immoveable relative to the holder while the mating port of the second guest connector of the guest connector set defining round symmetrical configuration, is moveable relative to the holder.

16. The connection system as claimed in claim 14, wherein the extension direction is also perpendicular to the front-to-back direction.

17. The connector system as claimed in claim 16, wherein said front-to-back direction is also an axial direction of the ferrule.

18. A cable connector assembly comprising:
a holder enclosing a first connector, which essentially defines a rectangular mating port, and a second connector, which essentially defines a round mating port, side by side arranged with each other; and
a ferrule disposed in the holder and surrounding one of said first connector and said second connector to have said one of the first connector and the second connector moveable in the ferrule via support of a plurality of spring tangs unitarily extending inwardly from a main portion of the ferrule; wherein
each of the spring tang extends in a transverse direct perpendicular to an axial direction of the ferrule.

19. The cable connector assembly as claimed in claim 18, wherein all said spring tangs extend commonly either clockwise or counterclockwise.
